(19) United States
(12) Patent Application Publication
(10) Pub. No.: US 2026/0119664 A1
(43) Pub. Date: Apr. 30, 2026

(54) MANAGEMENT OF ARTIFICIAL INTELLIGENCE-BASED SYSTEMS

(71) Applicant: Dell Products L.P., Round Rock, TX (US)

(72) Inventor: DHARMESH M. PATEL, Round Rock, TX (US)

(21) Appl. No.: 18/932,838

(22) Filed: Oct. 31, 2024

(51) Int. Cl. G06F 21/56

(52) U.S. Cl. CPC G06F 21/566; G06F 2221/034

(57) ABSTRACT

Methods, systems, and devices are provided for managing operation of a system. To do so, a suspect signature may be obtained based on an artificial intelligence architecture used by a suspect system. A relevant signature may be obtained using information regarding managed artificial intelligence based systems, the suspect system not being any of the managed systems. A level of similarity may be identified between the suspect signature and the relevant signature, and if the level of similarity meets criteria, it may be concluded that the suspect system has an unauthorized configuration. Based on this conclusion, at least one action may be performed to initiate update of the suspect system's operation to prevent use of the unauthorized configuration in computer implemented services provided by the suspect system.

### FIELD

Embodiments disclosed herein relate generally to management of data processing systems. More particularly, embodiments disclosed herein relate to systems and methods for management of artificial intelligence based systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating data processing systems in accordance with an embodiment.

FIGS. 2A-2B show data flow diagrams illustrating management of system operations in accordance with an embodiment.

FIGS. 2C-2H show structural diagrams illustrating graph data structure examples in accordance with an embodiment.

FIG. 3 shows a flow diagram illustrating a method for managing operation of a system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide, at least in part, computer implemented services. The computer implemented services may be provided to any type and/or number of other devices and/or users of the data processing systems. Furthermore, the provided computer implemented services may be of any quantity and/or type of such services.

To provide the computer implemented services, data processing systems may include hardware components and/or software components. For example, operation of these components may facilitate various functionalities of a data processing system, thereby causing the data processing system to provide the computer implemented services. Additionally, such operation of the components may depend on how such components interact with one another and/or data each component may be adapted to use, for example, as specified by a system architecture in which these components may be a part.

For example, by changing how the components interact with one another, thereby changing the system architecture, the operation may be updated, and thus, may facilitate the various functionalities in a different (e.g., new) manner and/or facilitate new functionalities all together than those prior to the update. Consequently, if the components are not configured to be in a correct architecture, then the services may not be provided as expected or desired by a consumer of such services (e.g., correct services may not be provided as expected and/or desired by a service providing entity).

To increase a likelihood of providing computer implemented services as expected and/or desired by a consumer of such services, a distributed system may include an architectural regulation framework.

This architectural regulation framework may include (i) obtaining information regarding architectures used by various systems associated, for example, with the consumer, (ii) identifying a suspect system of the various systems to be, for example, audited, and a respective architecture used by the suspect system, (iii) obtaining information specifying various disclosed (e.g., disclosed somehow to the consumer) architectures, the suspect system not having permission/authority to use any of the disclosed architectures, (iv) identifying a level of similarity between the architecture used by the suspect system and the disclosed architectures, and (v) performing a regulatory action set (e.g., system management actions) based on whether the identified level of similarity meets criteria, this performance of the regulatory action set facilitating management of the suspect system's operation.

In an embodiment, a method for managing operation of a system is provided.

The method may include obtaining, for a suspect system of an operator, a suspect signature based on an artificial intelligence architecture used by the suspect system; obtaining a relevant signature using a knowledge base of proprietary artificial intelligence architectures and information regarding managed artificial intelligence based systems that are managed on behalf of the operator, the suspect system not being any of the managed systems, and the relevant signature being based on a subset of the knowledge base used by the managed systems; identifying a level of similarity between the suspect signature and the relevant signature; and in an instance of the identifying where the level of similarity meets criteria: concluding that the suspect system has an unauthorized configuration, and performing at least one action to initiate updating of operation of the suspect system to prevent use of the unauthorized configuration in computer implemented services provided by the suspect system.

The obtaining of the suspect signature may include, for each component of components of the artificial intelligence architecture adding, to a graph data structure, a node corresponding to the component; populating the node with information regarding properties of the component; identifying relationships between the component and other component of the components; and establishing, between the node and other nodes corresponding to the other components, edges based on the relationships.

The components may include software components that provide artificial intelligence services; and hardware components used by the software components.

The populating of the node may include, in an instance of the populating where the node corresponds to one of the software components associating configuration settings of the one of the software components with the node; associating a portion of the artificial intelligence services to which the one of the software components contributes to the node; and associating information regarding data used by the one of the software components in the portion of the artificial intelligence services to the node.

The populating of the node may further include, in an instance of the populating where the node corresponds to one of the hardware components associating configuration settings of the one of the hardware components with the node; associating a portion of the artificial intelligence services to which the one of the hardware components contributes to the node; and associating information regarding data used by the one of the hardware components in the portion of the artificial intelligence services to the node.

The identifying of the relationships may include, in an instance of the populating where the node corresponds to one of the software components identifying sources of information used by the one of the software components; identifying a portion of the other nodes corresponding to other software components that are the sources of the information; establishing a portion of the edges between the one of the software components and the portion of the other nodes; and applying, to each edge of the portion of the edges, a label indicating that other software components corresponding to the portion of the nodes are the sources of the information and/or a flow direction of the information.

The identifying of the relationships may further include, in an instance of the populating where the node corresponds to one of the software components identifying sources of information used by the one of the software components; identifying a portion of the other nodes corresponding to hardware components that are the sources of the information; establishing a portion of the edges between the one of the software components and the portion of the other nodes; and applying, to each edge of the portion of the edges, a label indicating that hardware components corresponding to the portion of the nodes are the sources of the information and/or a flow direction of the information.

The identifying of the relationships may further include, in an instance of the populating where the node corresponds to one of the hardware components identifying sources of information used by the one of the hardware components; identifying a portion of the other nodes corresponding to software components that are the sources of the information; establishing a portion of the edges between the one of the hardware components and the portion of the other nodes; and applying, to each edge of the portion of the edges, a label indicating that other software components corresponding to the portion of the nodes are the sources of the information and/or a flow direction of the information.

The relevant signature may be based on a portion of the knowledge base that has been disclosed to the operator through being managed on behalf of the operator.

The level of similarity may be identified using a subgraph comparison process where portions of the suspect signature are attempted to be matched to portions of the relevant signature.

The criteria may be a threshold level of similarity.

In an embodiment, a non-transitory media is provided. The non-transitory media may include instructions that when executed by a processor cause, at least in part, the computer-implemented method to be performed.

In an embodiment, a data processing system is provided. The data processing system may include the non-transitory media and a processor and may, at least in part, perform the method when the computer instructions are executed by the processor.

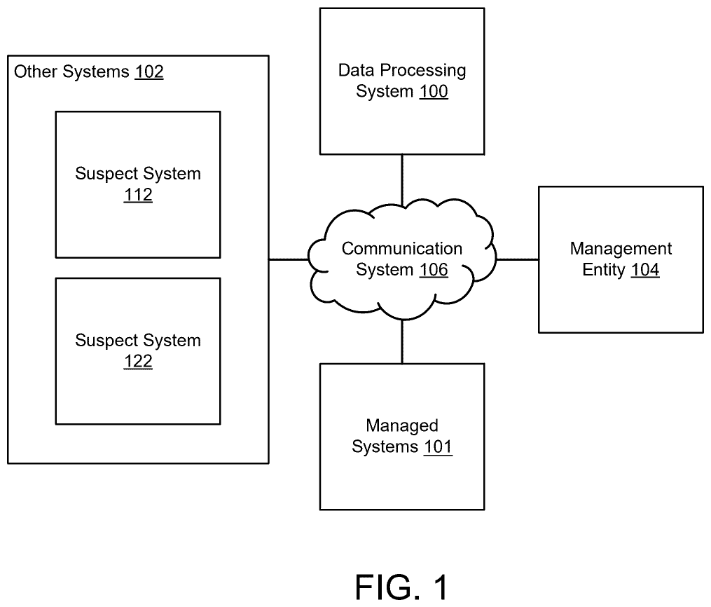

Turning to FIG. 1, a block diagram illustrating a system in accordance with an embodiment is shown. The system shown in FIG. 1 may be a distributed system that provides computer implemented services.

These services may include any type and/or quantity of services. These services may include, for example, database services, data processing services, electronic communication services, and/or any other services that may be provided by one or more computing devices.

Other types of services may be provided by the system shown in FIG. 1 without departing from embodiments disclosed herein.

To provide these services, the system may include any number of data processing systems (e.g., computing devices) such as data processing system 100. These data processing systems may include any quantity of software components and/or hardware components. These components may include, for example, processors, memory modules, storage devices, communications devices, power components, software applications, device drivers, and/or any other type of component whose respective operation may facilitate various functionalities of the data processing systems. By facilitating such functionalities of the data processing systems, the respective operation of such components may cause the services to be provided.

However, this operation of the hardware components and/or the software components may depend on an architecture of the components used during such operation. For example, the architecture of the components may determine which of the components may contribute to the operation, and how the contributing components may be configured to (i) interact with one another during the operation, and/or (ii) utilize various types and/or quantities of data. Consequently, if the components are not configured to be in a correct architecture, then the services may not be provided as expected or desired by a consumer of such services (e.g., correct services may not be provided as expected and/or desired by a service providing entity).

To increase a likelihood of providing computer implemented services as expected and/or desired by a consumer of such services, a distributed system may include components such as those illustrated and discussed with regard to FIG. 1, below.

In general, embodiments disclosed herein relate to systems, devices, and methods for managing operation of a system that may provide computer implemented services. To do so, an architectural regulation framework may be leveraged.

This architectural regulation framework may include (i) obtaining information regarding a knowledge base of proprietary artificial intelligence architectures used by various artificial intelligence based systems, (ii) identifying both a suspect system to be, for example, audited, and a respective artificial intelligence architecture used by the suspect system, (iii) obtaining information regarding various disclosed (e.g., disclosed to the consumer) architectures from the knowledge base, the suspect system not having permission/authority to use any of the disclosed architectures, (iv) identifying a level of similarity between the architecture used by the suspect system and the disclosed architectures, and (v) performing a regulatory action set (e.g., system management actions) based on whether the identified level of similarity meets criteria, this performance of the regulatory action set facilitating management of the suspect system's operation.

In doing so, a likelihood of providing the services as expected and/or desired by the consumer of the services may be increased. For example, this increased likelihood may be due to performance of system management actions based on, for example, identifying a level of similarity associated with the suspect system. For example, the level of similarity may be indicative of another likelihood regarding whether the architecture used by the suspect system includes an unauthorized configuration.

The unauthorized configuration may be based on configurations authorized for respective use by only a number of specific artificial intelligence based systems, the unauthorized configuration being one of and/or based heavily on the configurations of the disclosed architectures not authorized for use by the suspect system. For example, should the suspect system use the unauthorized configuration to provide services, these services may not be provided as expected and/or desired due to the suspect system's lack of permission to use the unauthorized configuration during its operation. Therefore, because such use by the suspect system may not be expected and/or desired, the services provided due to such use may also not being as expected and/or desired.

For example, should the suspect system use the unauthorized configuration, it may be concluded that the architecture used by the suspect system (and therefore, the suspect system itself) shares a high level of similarity with at least one of the specific systems and/or any of the configurations from the disclosed architectures used by the specific systems authorized to do so. For example, such similarity may be unlikely without the suspect system using the unauthorized configuration due to an intractable complexity of computations required for such an accidental level of similarity between artificial intelligence based systems and architectures. Therefore, it may be further concluded that such an accidental level (e.g., an accidentally high level) of similarity indicates that the architecture used by suspect system may be, for example, based heavily on and/or directly copied from the specific systems authorized to use the configurations. Thus, due to the architecture used by the suspect system not being authorized to include the unauthorized configuration, using the unauthorized configuration to provide services may not be expected and/or desired, thereby causing the services to not be provided as expected and/or desired.

Thus, to increase the likelihood of providing services such as artificial intelligence based services as expected and/or desired by the consumer of the services and/or the service providing entity, operation of an artificial intelligence based system that may be responsible for providing the services (e.g., the suspect system) may be managed using the previously mentioned architectural regulation framework.

To provide the above noted functionality, the system of FIG. 1 may include data processing system 100, managed systems 101, other systems 102, management entity 104, and communication system 106. Each of these components is discussed below.

Data processing system 100 may (i) host (and/or otherwise operate) a number of systems that may each use respective architectures to provide, at least in part, the previously mentioned services, (ii) communicate with various systems, devices, and/or entities within the system of FIG. 1 (e.g., managed systems 101, other systems 102, management entity 104, and/or other devices not explicitly shown in FIG. 1) via, for example, operable connections that facilitate data transmissions, and/or (iii) cooperate with the various systems, devices, and/or entities (e.g., management entity 104) to facilitate the previously mentioned architectural regulation framework.

The number of systems that may be hosted by data processing system 100 may include, for example, (i) at least one of the specific systems (previously mentioned) that may be managed on behalf of data processing system 100 (e.g., one of managed systems 101, discussed further below) and (ii) at least one system (e.g., 112 or 122 of other systems 102) that may not be managed on behalf of data processing system 100, but that may be suspected of using an unauthorized configuration (e.g., and as such, may be audited), as previously discussed.

To provide its functionality, data processing system 100 may be implemented by an operator. This operator may include, for example, any number of the hardware components and/or the software components to facilitate operation of data processing system 100, thereby causing computer implemented services to be provided. This operation may be facilitated based on respective architectures used by the hosted systems (e.g., via internal networks of interconnections between the components whose use depends on their configurations and configurations of each of the components). For example, such operation may depend on the types and/or quantities of the components, how such components interact with one another, and/or data each component may be adapted to use, for example, as specified by the architectures in which these components may be a part. Therefore, modifying any aspect of such architectures may also modify the operation, and thus, may result in modifying the services based on the modified operation.

The hosted and/or otherwise operated systems may be implemented by, for example, a diverse quantity of artificial intelligence based systems that may use and/or that may be facilitated by the hardware components and/or the software components of data processing system 100 to contribute to the provided services. Each of these systems is discussed below.

Managed systems 101 may (i) use a portion (e.g., a subset) of a knowledge base of proprietary artificial intelligence architectures (e.g., such proprietary status being due to an association with a managing entity (e.g., the service proving entity) that has authority to use and/or manage such architectures and/or to manage permissions to use such architectures) to contribute to the provided services, managed systems 101 being explicitly bestowed permissions and/or an authority to use the portion of the knowledge base (e.g., by the managing entity), (ii) be managed on behalf of the operator (e.g., by the management entity), (iii) be disclosed to the operator, due to being managed on behalf of the operator, along with a number of proprietary architectures (e.g., the portion used by the managed systems 101) from the portion of the knowledge base also being disclosed, (iv) communicate (e.g., regarding the portion of the knowledge base) with the various systems, devices and/or entities in the system of FIG. 1, and/or (v) cooperate with the various systems, devices and/or entities (e.g., management entity 104) in the system of FIG. 1 to facilitate the previously mentioned architectural regulation framework.

To provide its functionality, managed systems 101 may include any number of artificial intelligence based systems that are managed on behalf of the operator as mentioned above. Consequently, through being managed on behalf of the operator, the portion of the knowledge base used by managed systems 101 may be disclosed to the operator. Consequently, such disclosure may facilitate, for example, a vulnerability regarding the knowledge base. This vulnerability may be associated, for example, with proprietary knowledge that is associated with the management entity being at risk of non-proprietary use. This risk of non-proprietary use may be due to, for example, the consumer, by some means, identifying a configuration of the disclosed architectures based on the disclosure, and plagiarizing at least a portion of the disclosed architecture to obtain a suspect architecture by including the identified configuration (e.g., now considered an unauthorized configuration) in the suspect architecture for use by a system that is not managed of behalf of the operator to provide additional services, for example, without regard for the management entity.

Therefore, although there may be portions of the knowledge base disclosed to the operator, any systems attempting to use any portion of the knowledge base may require explicit permission and/or authority to do so. Such explicit permissions may be obtained via authority exercised by the managing entity associated with the proprietary artificial intelligence architectures, and each of managed systems 101 being provided at least a portion of such explicit permissions.

Other systems 102 may (i) use any number of artificial intelligence architectures that may or may not be based on the portion of the knowledge base to contribute to the provided services, (ii) not be provided explicit permissions required to use any of the portion of the knowledge base, (iii) include artificial intelligence based systems (e.g., suspect systems) whose operation may be managed by, for example, the management entity (e.g., 104, discussed further below), (iv) communicate (e.g., regarding the any number of the artificial intelligence architectures) with the various systems, devices, and/or entities in the system of FIG. 1, and/or (v) cooperate with the various systems, devices, and/or entities in the system of FIG. 1 to facilitate the previously mentioned architectural regulation framework.

To provide its functionality, other systems 102 may include suspect system 112 and/or suspect system 122 (e.g., either of these systems being example embodiments of the previously mentioned suspect system associated with the operator). For example, suspect systems 112 and/or 122 may be systems that are not managed on behalf of the operator. Consequently, suspect systems 112 and 122 are each unlikely to have a level of similarity, which is based on comparisons to any of managed systems 101, that is above a similarity threshold (assuming suspect systems 112 and/or 122 do not include unauthorized configurations).

Therefore, if a level of similarity (based on comparisons between a respective system and any of managed systems 101) is above a similarity threshold for either of suspect systems 112 and/or 122, it may be concluded that suspect system 112 and/or 122 is likely to include an unauthorized configuration that is based on a configuration authorized for use by at least one of managed systems 101, as previously discussed.

To manage the risk of such suspect systems using architectures that include unauthorized configurations, the architectural regulation framework may be leveraged. In some cases, for example, management entity 104 may be a primary facilitator of the architectural regulation framework.

To do so, management entity 104 may (i) obtain graph data structures to depict artificial intelligence architectures of the managed systems (e.g., 101) and of each suspect system, (i) identify the level of similarity between managed systems 101 and each suspect system using the obtained graph data structures to perform a subgraph comparison analysis, (ii) determine, based on the subgraph comparison analysis, whether the level of similarity identified for each suspect system is at (and/or exceeding) or falls short of the similarity threshold specified by criteria, and/or (iii) based on this similarity threshold being met, initiate a regulatory action set to update operation of at least one of the suspect systems. This update to the suspect system's operation may thereby enable the suspect system to provide the services as expected and/or required (e.g., without using unauthorized configurations).

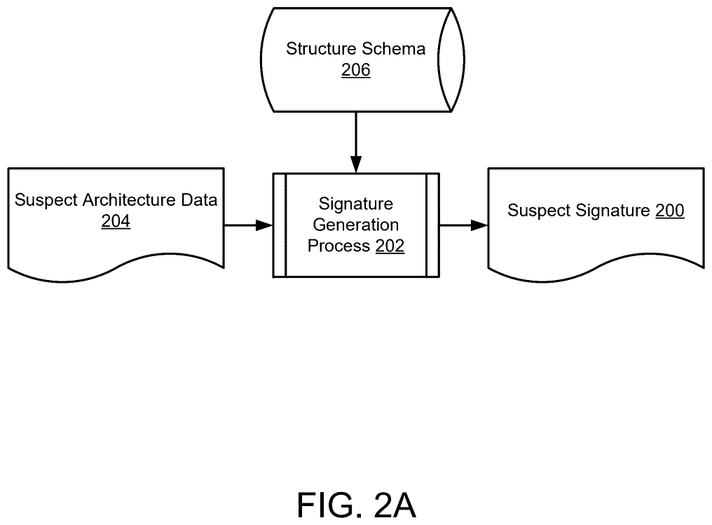

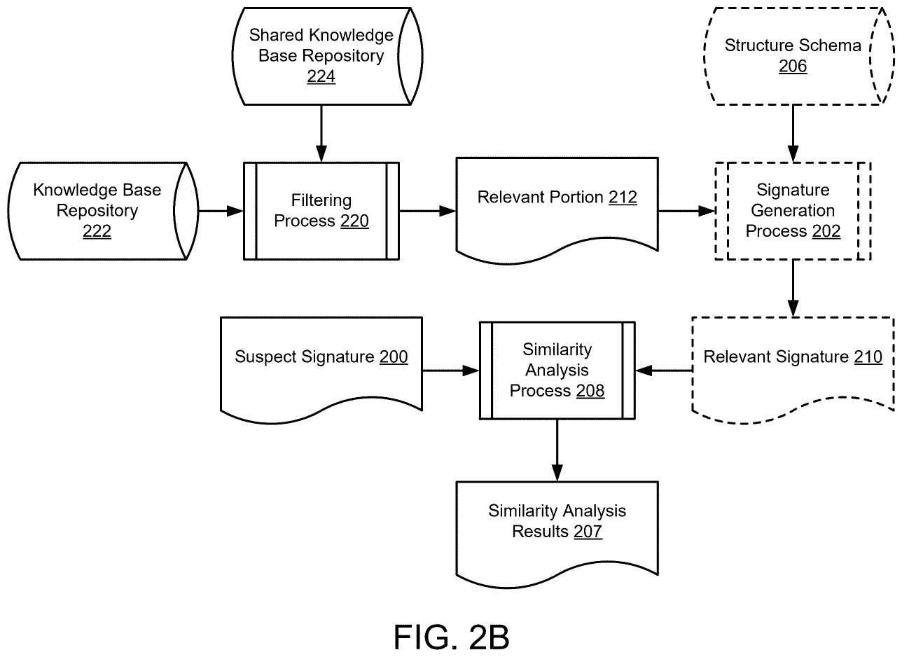

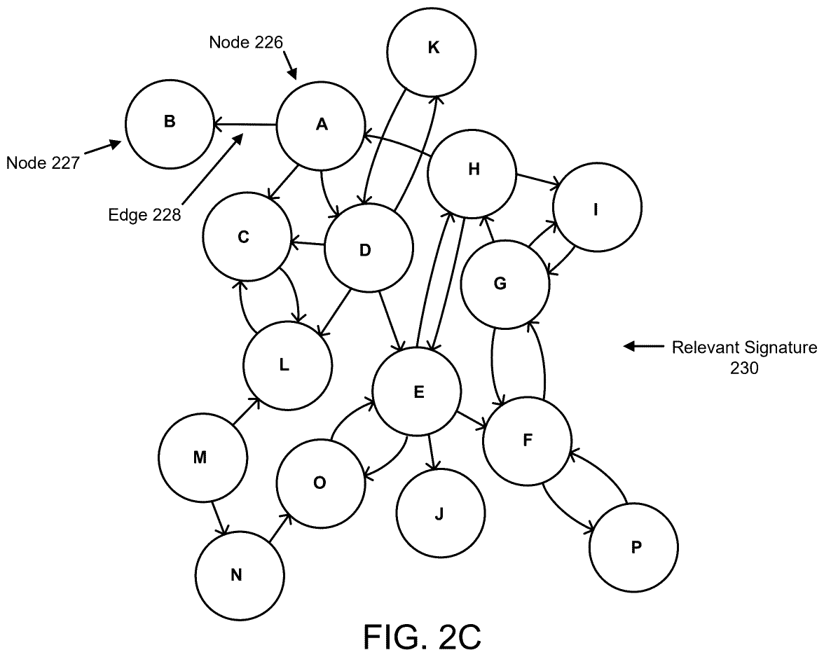

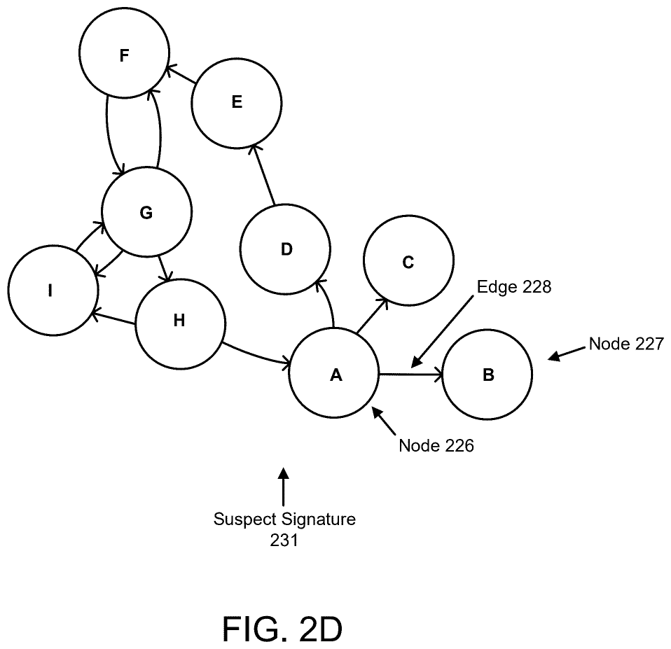

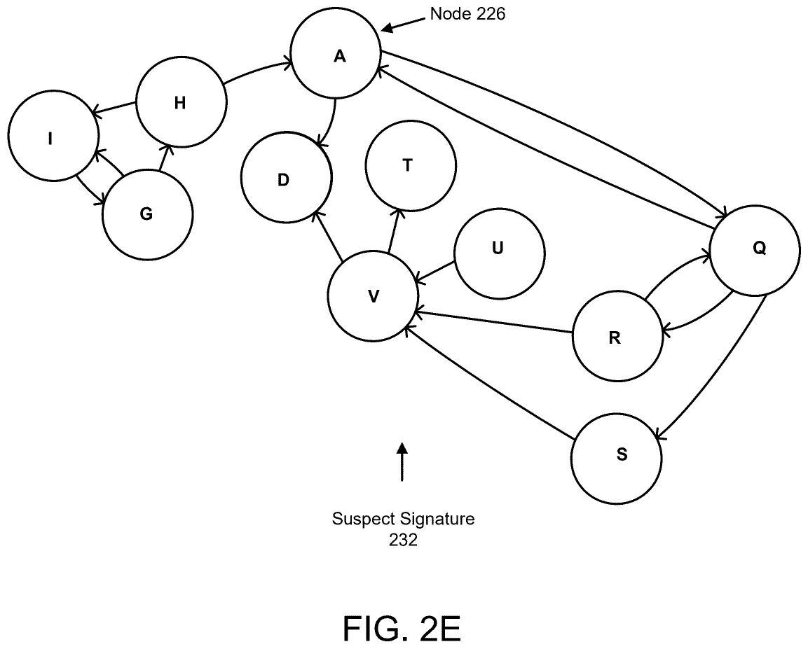

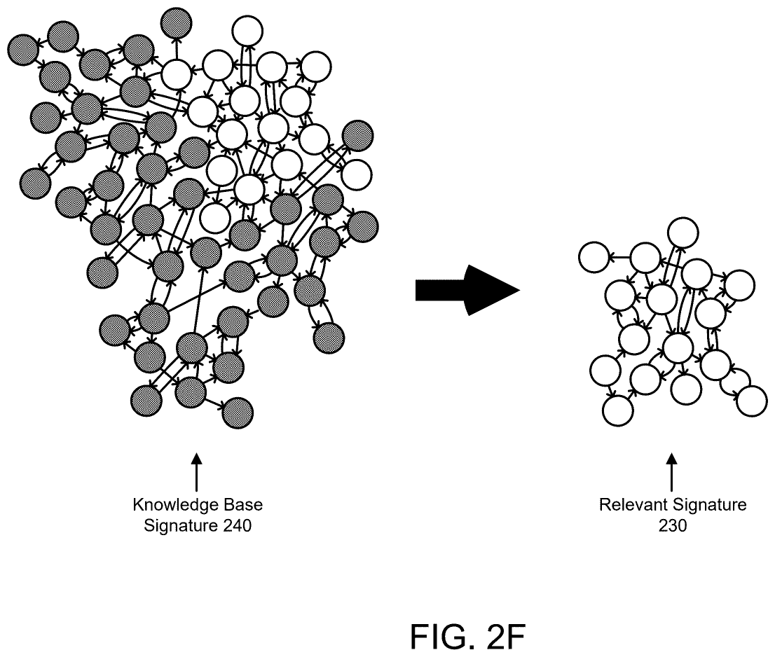

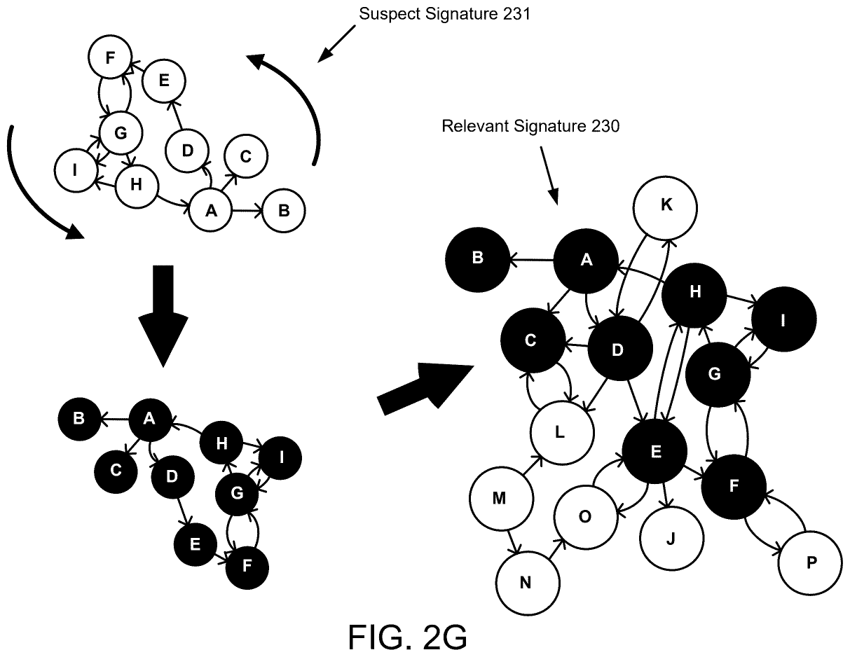

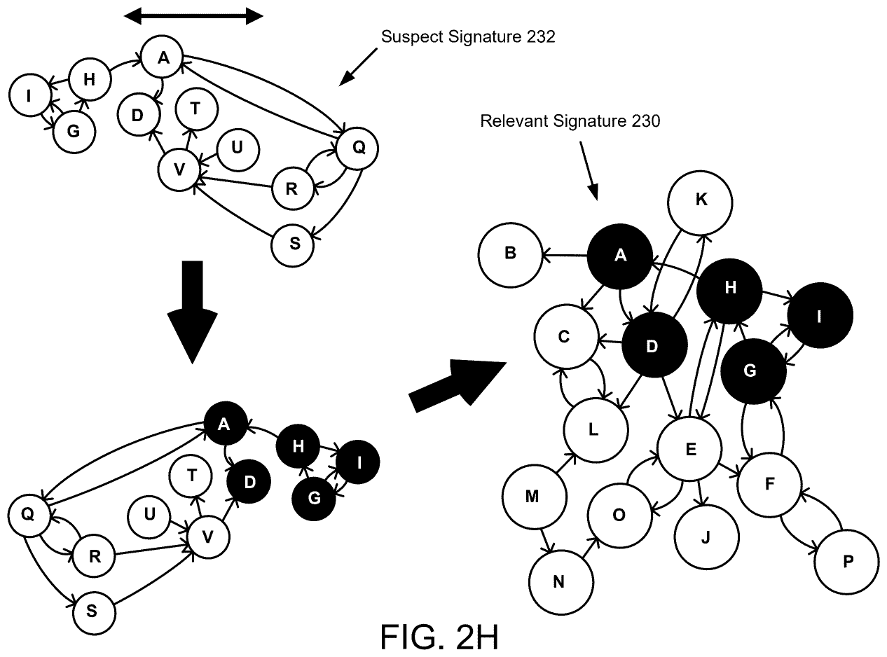

For additional information regarding how the graph data structures may be obtained for each of the suspect systems and/or the managed systems, refer to FIGS. 2A-2B discussed further below. For additional information regarding the subgraph comparison analysis, refer to FIG. 2B discussed further below.

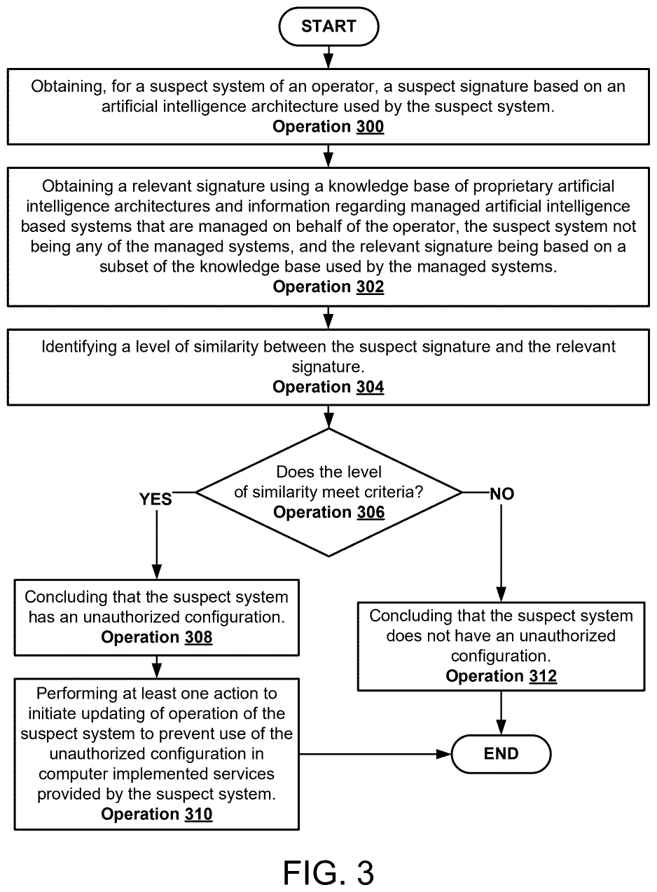

When providing their functionality, data processing system 100, managed systems 101, other systems 102, and/or management entity 104 may perform all, or a portion, of the method shown in FIG. 3. Any devices (and/or components thereof) included in the system of FIG. 1 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system.

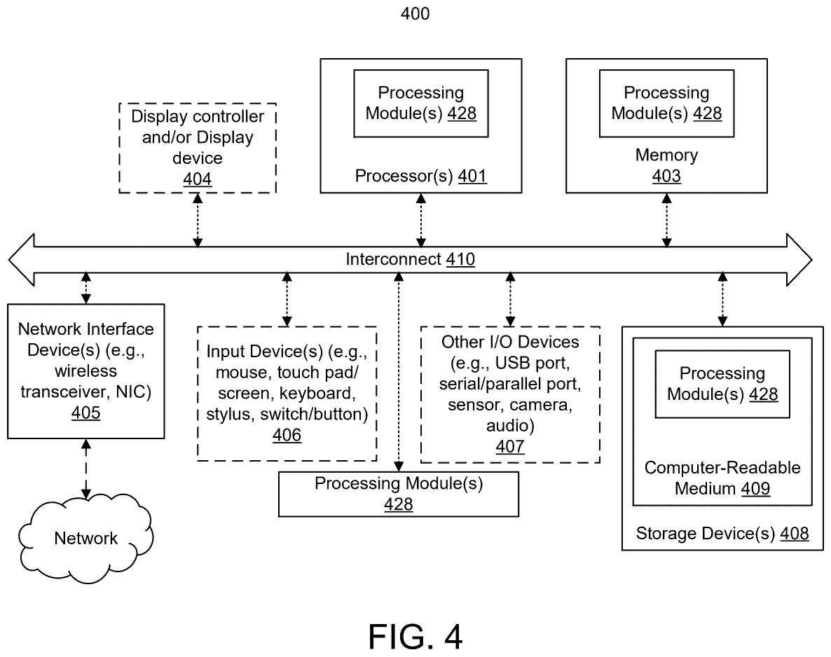

For additional details regarding computing devices, refer to FIG. 4.

Any of the components illustrated in FIG. 1 may be operably connected to each other (and/or components not illustrated) with a communication system (e.g., 106) utilized by data processing system 100, managed systems 101, other systems 102, and/or management entity 104 to, for example, cooperate with one another to facilitate the architectural regulation framework.

In an embodiment, this communication system may include one or more networks that facilitate communication between any number of components. The networks may include wired networks and/or wireless networks (e.g., and/or the Internet). The networks may operate in accordance with any number and types of communication protocols (e.g., such as the internet protocol).

Thus, by facilitating such a framework as the architectural regulation framework, there may be an increased likelihood of providing computer implemented services as expected and/or desired by a consumer of such services (e.g., as expected and/or desired by the previously mentioned managing entity) by reducing a likelihood of providing such services using an unauthorized configuration. Such an unauthorized configuration may, for example, be included in artificial intelligence based systems outside of managed systems 101, the unauthorized configuration sharing an unlikely level of similarity with at least one configuration included in at least a portion of the number of proprietary architectures used by the managed systems that are managed on behalf of the operator (e.g., sharing an unlikely level of similarity with configurations included in at least a portion of managed systems 101).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2B. These data flow diagrams may illustrate how data may be obtained and used within the system of FIG. 1.

In the data flow diagrams, such as in FIGS. 2A-2B, flows of data and processing of data are illustrated using different sets of shapes. In the context of these data flow diagrams, a first set of shapes (e.g., 200, 204, etc.) is used to represent data structures, a second set of shapes (e.g., 202, etc.) is used to represent processes performed using and/or that generate data, and a third set of shapes (e.g., 206, etc.) is used to represent large scale data structures such as databases (e.g., that include some type of schema).

Turning to FIG. 2A, a first data flow diagram in accordance with an embodiment is shown. The first data flow diagram may illustrate data used in and data processing performed in at least part of the architectural regulation framework. For example, the first data flow diagram may illustrate data used in and data processing performed in obtaining a graph data structure to depict an artificial intelligence architecture of a (e.g., suspect) system. Therefore, as shown in FIG. 2A, a suspect signature (e.g., 200) may be obtained.

To obtain suspect signature 200, signature generation process 202 may be performed. During signature generation process 202, (i) suspect architecture data 204 and (ii) structure schema 206 may be ingested. Once ingested, suspect architecture data 204 may be subjected to any number of filtering and analysis processes. Some of the filtering and analysis processes may be defined by schema maintained by structure schema 206.

For example, signature generation process 202 may obtain a schema from schema structure 206 corresponding to information from suspect architecture data 204. In this example, suspect architecture data 204 may include data (e.g., information) regarding a suspect system such as either of suspect systems 112 and/or 122 shown in FIG. 1. This data may specify, as part of the architecture used by the suspect system, hardware components and/or software components whose operation is at least in part required, information used by such components during their operation, and/or information regarding relationships facilitated between such components during their operation. Additionally, the schema from structure schema 206 corresponding to the data from suspect architecture data 204 may include a set of rules for generating a graph data structure to depict the artificial intelligence architecture used by the suspect system.

It will be appreciated that structure schema 206 may include schema corresponding to information from any system. Consequently, a graph data structure generated by performance of signature generation process 202 may be based on whatever system is associated with respectively ingested data to facilitate the performance. For example, if data regarding a managed system from managed systems 101 is ingested into signature generation process 202, schema from structure schema 206 corresponding to the ingested data may be used with the ingested data to generate a graph data structure to depict an artificial intelligence architecture used by the managed system (discussed further with regard to FIG. 2B).

For example, signature generation process 202 may use suspect architecture data 204 as a key to perform a lookup for any number of corresponding schema stored in structure schema 206. Once obtained, various actions (e.g., graph data structure generation actions) specified by the schema may be performed based on and/or using the ingested suspect architecture data 204 to complete a first signature generation process (e.g., 202). Once completed, this performance of signature generation process 202 may result in obtaining suspect signature 200.

Suspected signature 200 may specify the same data as that mentioned above with respect to suspect architecture data 204, however, suspect signature 200 may specify such data by, for example, providing a visual depiction of the data.

For example, the schema from structure schema 206 may include instructions for adding, to a graph data structure to depict the artificial intelligence architecture used by the suspect system, nodes corresponding to the components. For example, during signature generation process 202, the nodes may be added as such. Once added, these nodes may be populated with information regarding the components in addition to relationship information between the components. Such relationship information may be used to establish edges between the nodes. Thus, the graph data structure depicting the architecture used by the suspect system may be obtained based on the suspect architecture data 204, the graph data structure being implemented by suspect signature 200.

It will be appreciated that suspect signature 200 may be used during another part of the architectural regulation framework. For additional information regarding how suspect signature 200 may be used, refer to FIG. 2B, below.

Turning to FIG. 2B, a second data flow diagram in accordance with an embodiment is shown. The second data flow diagram may illustrate data used in and data processing performed in at least part of the architectural regulation framework. For example, as shown in FIG. 2B, the second data flow diagram may illustrate data used in and data processing performed in obtaining a similarity analysis result (e.g., 207) using, for example, the previously discussed suspect signature (e.g., 200).

To obtain similarity analysis result 207, similarity analysis process 208 may be performed. During similarity analysis process 208 (i) suspect signature 200 and (ii) relevant signature 210 may be ingested. Once ingested, suspect signature 200 and relevant signature 210 may be subjected to a subgraph comparison process where portions of suspect signature 200 are attempted to be matched to portions of relevant signature 210, discussed further below. Both these signatures may thereby be required to obtain similarity analysis result 207 from performance of similarity analysis process 208. However, although suspect signature 200 may be obtained as discussed with regard to FIG. 2A, relevant signature 210 may, in some cases, be obtained via different means, discussed further below.

To perform the subgraph comparison analysis, suspect signature 200 and relevant signature 210 may be implemented by respective graph data structures, thereby being comparable through the subgraph comparison process as mentioned above. For example, the subgraph comparison process may result in similarity analysis result 207, this result indicating how similar the ingested graph data structures are with one another when compared. This similarity may in turn indicate a likelihood of, for example, unauthorized configurations being included in the artificial intelligence architecture used by the suspect system, the architecture being depicted by suspect signature 200. In contrast, the previously mentioned specific systems authorized to use the also previously mentioned disclosed architectures from the portion of the knowledge base may have such disclosed architecture depicted by relevant signature 210, discussed below.

For additional information regarding the subgraph comparison process (e.g., similarity analysis process 208), refer to FIGS. 2G-3, further below.

Relevant signature 210 may be a graph data structure depicting one or more artificial intelligence architectures that may have been disclosed to the operator by being used by any number of managed systems that are managed on behalf of the operator as discussed with regard to FIG. 1.

It will be appreciated that, in some cases, relevant signature 210 may be obtained via a similar process to that described with regard to obtaining suspect signature 200 in FIG. 2A. That is why, as shown in FIG. 2B, relevant signature 210, signature generation process 202, and structure schema 206 are illustrated with dashed borders. However, in contrast to the process illustrated in FIG. 2A, the signature generation process 202 shown in FIG. 2B may include ingestion of relevant portion 212 rather than suspect architecture data 204.

For example, relevant portion 212 may include data (e.g., information) regarding any number of such disclosed architecture used by systems managed on behalf of the operator such as any of managed systems 101 shown in FIG. 1. This data may specify, as part of the disclosed architectures used by the managed systems, hardware components and/or software components whose operation is at least in part required, information used by such components during their operation, and/or information regarding relationships facilitated between such components during their operation. Additionally, the schema from structure schema 206 corresponding to the data from relevant portion 212 may include a set of rules for generating a graph data structure to depict the disclosed architectures used by the managed systems. To obtain relevant portion 212, for example, filtering process 220 may be performed.

During filtering process 220, (i) knowledge base repository 222 and (ii) shared knowledge base repository 224 may be ingested. Once ingested, knowledge base repository 222 may be subjected to any number of filtering processes that are based on information obtained from shared knowledge base repository 224.

Knowledge base repository 222 may include all data regarding all artificial intelligence architectures that are, for example, considered to be proprietary information of (e.g., belonging to) the previously mentioned service providing entity. For example, this may be an entity whose authority may be exercised by performed functionalities of management entity 104 (e.g., exercised via facilitation of the architectural regulation framework).

For example, through being managed on behalf of the operator, the portion of the knowledge base used by the managed systems may be disclosed to the operator. Consequently, such disclosure may facilitate a vulnerability regarding proprietary knowledge that is associated with the management entity being at risk of non-proprietary use, thereby providing a risk of not providing the discussed services as expected and/or desires due to using unauthorized configurations. Therefore, although there may be portions of the knowledge base disclosed to the operator, any systems attempting to use any portion of the knowledge base may require explicit permission and/or authority to do so. Such explicit permissions may be obtained via authority exercised by, for example, management entity 104 in FIG. 1 (104 being associated with the proprietary artificial intelligence architectures such as with the previously mentioned service providing entity). For example, to respectively use the disclosed architectures, each of managed systems 101 may be provided at least a portion of such explicit permissions required for corresponding architectures of the disclosed architectures.

Shared knowledge base repository 224 may therefore associate the operator (on whose behalf managed systems may be managed, for example, by management entity 104) with a subset of knowledge base 222. This association between the operator and the subset of knowledge base 222 may be implemented by, for example, identification data and/or association data regarding the operator (e.g., and/or otherwise regarding the consumer).

For example, shared knowledge base repository 224 may include (i) the identification data used to identify an operator (e.g., the operator mentioned above) of various operators for whom systems may be managed on behalf of by the management entity, and (ii) association data that respectively associates each of the various operators with respectively disclosed-to portions of knowledge base 222.

It will thus be appreciated, for example, that portions of knowledge base 222 disclosed to the operator may be associated with the operator via the association data, the operator being discriminated from any other operators using the identification data.

Therefore, the any number of filtering processes that knowledge base 222 may be subjected to (based on data from shared knowledge base 224) may result in an output of relevant portion 212 from filtering process 220.

It will be further appreciated that in some other cases, for example, relevant signature 210 (rather than being obtained based on ingesting relevant portion 212 into signature generation process 202, as previously discussed) may instead be implemented by relevant portion 212 (e.g., in such cases, relevant portion 212 and relevant signature 210 may be one and the same). In such a case, for example, relevant portion 212 may be the graph data structure described previously with regard to relevant signature 210.

Furthermore, for example, knowledge base 222 may be implemented in this such case by a (e.g., larger) graph data structure that depicts all the artificial intelligence architectures that are, for example, considered to be part of the proprietary information of (e.g., belonging to) the management entity. Therefore, based on what shared knowledge base repository 224 is previously discussed to include, this larger data structure may be filtered based on shared knowledge repository 224 to obtain a subset of knowledge base repository 222 that is depicted by a portion of the larger graph data structure. For example, this subset may be the same graph data structure as that described with regard to both relevant portion 212 and relevant signature 210 (to be referred to henceforth as “relevant signature 210” due to “the subset”, “relevant portion 212”, and “relevant signature 210” being too many names for continuous reference to relevant signature 210 without further complicating discussions herein).

For additional information regarding the obtaining of the relevant signature, refer to FIGS. 2C and 2F, further below.

Thus, FIGS. 2A-2B may illustrate data used in and data processing performed in at least part of the architectural regulation framework.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows shown in FIGS. 2A-2B, the architectural regulation framework may be facilitated. For additional information and/or examples regarding the architectural regulation framework, refer to FIGS. 2C-2H below.

To further clarify embodiments disclosed herein, structural diagrams in accordance with an embodiment are shown in FIGS. 2C-2H. These structural diagrams may illustrate examples of graph data structures and/or illustrate example processes that may be performed within the system of FIG. 1 that involve the examples of the graph data structures.

In the structural diagrams, such as in FIGS. 2C-2H, each example of a graph data structure may be illustrated using one or more (i) nodes depicted using circles, each circle including an alphabetical letter within its border, and (ii) edges depicted using lines, each line ending at an arrow and each line also spanning a distance between any two of the circles.

It will be appreciated that each example of a graph data structure may correspond to one or more artificial intelligence architectures. In the context of these structural diagrams, each node of a single graph data structure may correspond to a hardware component or a software component that is part of a respective artificial intelligence architecture, and each edge that spans between any two of the nodes may correspond to a relationship between components that correspond to the two nodes. Additionally, each alphabetical letter may be positioned within a node's border to represent populated information regarding properties of a component corresponding to said node. For example, each alphabetical letter of a node may represent (i) configuration settings of a component corresponding to the node, (ii) a portion of artificial intelligence services to which the corresponding component contributes to the node, and/or (iii) information regarding data used by the corresponding component in the portion of the artificial intelligence services. Thus, examples of, and/or example processes that involve, the graph data structures are discussed in FIGS. 2C-2H, below.

Turning to FIG. 2C, a first structural diagram in accordance with an embodiment is shown. It will be appreciated that the first structural diagram may illustrate a first example of a graph data structure, this first example being relevant signature 230. It will be further appreciated that relevant signature 230 may be a same graph data structure as that discussed with regard to relevant signature 210 in FIG. 2B, and as such, may be obtained via processes discussed with regard to FIGS. 1 and 2B.

As shown in FIG. 2C, relevant signature 230 may include node 226 (depicted using a circle populated by a letter “A”), node 227 (depicted using a circle populated by a letter “B”), and edge 228 (depicted by an arrow spanning a distance between nodes 226 and 227, the arrow pointing towards node 227 and away from node 226).

Assume, for example, that node 226 corresponds to a software component that may provide artificial intelligence services. Further assume that node 227 corresponds to a hardware component used by the software component. The arrow labeled edge 228 may correspond to a relationship between the software component and the hardware component. This relationship, for example, may be defined by (i) the software component being positioned at a starting point of edge 228 to indicate that the software component is performing the action of “using” the hardware component, and (ii) the hardware component being positioned at an end point of edge 228 where an arrow is located to indicate that the hardware component is what is “being used” by the software component. Thus, this relationship corresponding to edge 228 may be defined by the orientation of edge 228 relative to nodes 226 and 227.

Alternatively, for example, this relationship corresponding to edge 228 may indicate that the software component is performing the action of “providing” data to the hardware component, and the arrow leading to the hardware component may indicate that the hardware component is what is “being provided”the data by the software component.

Thus, it will be appreciated that such illustrative devices used in the above example (discussed above with regard to relevant signature 230) may be used to similarly define various aspects of, for example, the artificial intelligence architectures being portrayed in the following FIGS. 2D-2H, discussed below, along with the other nodes and edges shown but that may not be explicitly discussed in FIG. 2C-2H.

As previously discussed with regard to FIGS. 1 and 2B, the relevant signature may be based on the portion of the knowledge base that has been disclosed to the operator through being managed on behalf of the operator. Therefore, relevant signature 230 may be an example depiction of information regarding the portion of the knowledge base, this portion including, for example, configurations included in any number of the disclosed architectures used by the managed systems (e.g., 101 in FIG. 1). Consequently, by being disclosed to the operator, any of these configurations may facilitate a risk associated with a suspect system (e.g., a system that is not one of the managed systems) including an unauthorized configuration that is based on at least one of the configurations.

For additional information regarding how the relevant signature may be obtained, refer to FIG. 2F.

For additional information regarding how the relevant signature may be used, refer to FIGS. 2G-2H.

Turning to FIG. 2D, a second structural diagram in accordance with an embodiment is shown. It will be appreciated that this second structural diagram illustrates a first example of a suspect signature (e.g., a first example of suspect signature 200). This first example may be obtained via processes discussed with regard to the suspect signature in FIGS. 2A-2B. This first example is depicted using suspect signature 231, as shown FIG. 2D.

In FIG. 2D, suspect signature 231 may include node 226 (depicted using a circle populated by a letter “A”), node 227 (depicted using a circle populated by a letter “B”), and edge 228 (depicted by an arrow spanning a distance between nodes 226 and 227, the arrow pointing towards node 227 and away from node 226). It will be appreciated that these illustrative devices in FIG. 2D are labeled and positioned relative to one another similarly to some of the illustrative devices in FIG. 2C to highlight a level of similarity between the two data structures in FIGS. 2C and 2D. For example, assume the level of similarity between relevant signature 230 and suspect signature 231 is above a threshold of similarity defined by criteria as previously discussed with regard to similarity analysis process 208 in FIG. 2B.

For additional information regarding the threshold of similarity, refer to FIGS. 2G-2H, further below.

As previously discussed with regard to obtaining the suspect signature in FIG. 2A, the suspect signature (e.g., 231) may be obtained via a signature generation process (e.g., 202 in FIG. 2B). For example, this process may include obtaining data regarding a first suspect system (e.g., any of other systems 102 in FIG. 1) that is not one of the managed systems (e.g., not one of managed systems 101 in FIG. 1). Once obtained, this data may be subject to structural schema specifying rules/instructions for obtaining a graph data structure such as this first example (231) that portrays the artificial intelligence architecture used by the first suspect system. For example, assume that suspect signature 231 portrays the artificial intelligence architecture used by suspect system 112 (shown in FIG. 1) during discussion of FIGS. 2E-2H that follow below.

For additional information regarding how the first example may be used, refer to FIGS. 2G-2H.

Turning to FIG. 2E, a third structural diagram in accordance with an embodiment is shown. It will be appreciated that this third structural diagram illustrates a second example of the suspect signature discussed above. For example, this second example may be obtained via processes discussed with regard to the suspect signature in FIGS. 2A-2B. This second example is depicted using suspect signature 232, as shown FIG. 2E.

In FIG. 2E, suspect signature 232 may include node 226 (depicted using a circle populated by a letter “A”), however, suspect signature may not include node 227 (depicted in FIGS. 2C-2D using a circle populated by a letter “B”), nor edge 228 (depicted in FIGS. 2C-2D by an arrow spanning a distance between nodes 226 and 227, the arrow pointing towards node 227 and away from node 226). It will be appreciated that illustrative devices in FIG. 2E are labeled and positioned relative to one another differently (e.g., in a less similar manner, at least compared to those in FIG. 2D) from most of the illustrative devices in FIG. 2C to highlight a level of similarity between the two data structures of FIGS. 2C and 2E. For example, assume the level of similarity between relevant signature 230 and suspect signature 232 is below a threshold of similarity defined by criteria as previously discussed with regard to similarity analysis process 208 in FIG. 2B.

For additional information regarding the threshold of similarity, refer to FIGS. 2G-2H, further below.

As previously discussed with regard to obtaining the suspect signature in FIG. 2A, the second suspect signature (e.g., 232) may be obtained via a signature generation process (e.g., 202). For example, this process may include obtaining data regarding a second suspect system (e.g., any of other systems 102 in FIG. 1) that is not one of the managed systems (e.g., 101 in FIG. 1). Once obtained, this data may be subject to structural schema specifying rules/instructions for obtaining a graph data structure such as the second example that portrays an artificial intelligence architecture used by a suspect system.

For example, assume that suspect signature 232 portrays the artificial intelligence architecture used by suspect system 122 (shown in FIG. 1) during discussion of FIGS. 2F-2H that follow below.

For additional information regarding how the second example may be used, refer to FIGS. 2G-2H.

Turning to FIG. 2F, a fourth structural diagram in accordance with an embodiment is shown. It will be appreciated that this fourth structural diagram illustrates an example of a first process performed as part of the architectural regulation framework. For example, as shown in FIG. 2F, a filtering process (e.g., 220 in FIG. 2B) may be performed as part of the architectural regulation framework to obtain relevant signature 230.

It will be appreciated that, although not explicitly shown in FIG. 2F as including the alphabetical letters within each node's border (as shown in FIGS. 2C-2E) that represent populated information regarding properties of components, nodes of both relevant signature 230 and knowledge base signature 240 may each include the populated information (and therefore assumed to include the alphabetical letters despite not being explicitly illustrated). It will be further appreciated that, as discussed with regard to FIG. 2C, relevant signature 230 may be used as an example of relevant signature 200 discussed with regard to FIGS. 2A-2B.

As previously discussed with regard to FIG. 2B, the relevant signature (e.g., 230) may be based on one or more artificial intelligence architectures that may have been disclosed to the operator by being used by any number of managed systems (e.g., 101 in FIG. 1) that are managed on behalf of the operator. These disclosed architectures may be a portion (a subset) of the knowledge base of proprietary artificial intelligence architectures, the knowledge base including any number of such proprietary architectures. As shown in FIG. 2F, this knowledge base may be depicted using a large graph data structure (e.g., the large graph data structure mentioned with regard to FIG. 2B) such as knowledge base signature 240.

The large graph data structure of knowledge base signature 240 may include any number of nodes and any number of edges that is equal to or exceeding the number of nodes and the number of edges depicted by relevant signature 230. Additionally, these nodes and edges of knowledge base signature 240 may be oriented relative to one another in any number of ways. For example, such orientation may be based on schema as discussed with regard to FIG. 2B. Such schema may include rules and/or instructions for adding nodes to the large graph data structure, populating the nodes with information, and establishing edges between the nodes. These rules and/or instructions may, for example, be based on a type and/or a quantity of (i) component whose operation may be required to facilitate use of any of the proprietary architectures, (ii) data used by the component during the required operation, and (iii) information regarding relationships facilitated between the component and other components during the required operation.

As shown in FIG. 2F, a first portion (a larger of two portions) of the nodes of knowledge base signature 240 may be shaded with an in-fill pattern. In contrast, a second portion (a smaller of the two portions) of the nodes of knowledge base signature 240 may not be shaded, and thus may appear lighter than the first portion. This difference in shading between the first portion and the second portion of the nodes may be used in FIG. 2F to visually discriminate between the proprietary architectures included in the knowledge base based on a disclosure status of each of the proprietary architectures with regard to the operator. For example, the first portion of the nodes may correspond to undisclosed proprietary architectures from the knowledge base. In contrast, the second portion of the nodes may correspond to the disclosed architectures. Thus, the previously discussed portion of the knowledge base that has been disclosed to the operator may be highlighted by the lighter shade of the second portion of the nodes.

By highlighting the second portion of the nodes, FIG. 2F may illustrate an example for how knowledge base signature 240 may be filtered based on the state of disclosure for each of the proprietary architectures included in the knowledge base. For example, a black arrow is shown oriented between knowledge base signature 240 and relevant signature 230 in FIG. 2F, the black arrow pointing toward a right side of the page. This orientation may indicate a temporal shift from a left side of the page to the right side of the page during performance of the filtering process, thereby discriminating between knowledge base signature 240 prior to the filtering process (on the left side of the page) and relevant signature 230 as an outcome of the filtering process (on the right of the page).

Thus, the filtering process may be performed to obtain a signature that is, for example, relevant to the operator, the filtering process being performed as shown in FIG. 2F by filtering the knowledge base by discriminating the disclosed architectures from the undisclosed proprietary architectures. Such filtering may thereby result in the obtaining of relevant signature 230 as shown on the right side of the page.

For additional information regarding how the relevant signature may be used, refer to FIGS. 2G-2H, discussed below.

Turning to FIG. 2G, a fifth structural diagram in accordance with an embodiment is shown. It will be appreciated that this fifth structural diagram illustrates a first example of a second process performed as part of the architectural regulation framework. For example, as shown in FIG. 2G, a subgraph comparison process (e.g., similarity analysis process 208 in FIG. 2B) may be performed as part of the architectural regulation framework to obtain a similarity analysis results (e.g., 207 in FIG. 2G).

Previously discussed in FIGS. 2C-2E was the assumption that the level of similarity between relevant signature 230 and suspect signature 231 is above a threshold similarity defined by criteria. To identify the level of similarity between relevant signature 230 and suspect signature 231, similarity analysis process 208 mentioned with regard to FIG. 2B may be performed. For example, the similarity analysis process may include performing the subgraph comparison process where portions of suspect signature 231 are attempted to be matched to portions of relevant signature 230, as shown in FIG. 2G. Therefore, the assumption mentioned above may be based, for example, on each of the nodes of suspect signature 231, the edges of suspect signature 231, and the orientation of the nodes and the edges relative to one another of suspect signature 231 being almost identical to a portion of relevant signature 230.

For example, suspect signature 231 is depicted in FIG. 2G with arrows indicative of a reorientating of suspect signature 231 (and/or portions of suspect signature 231) until a most likely match is found within relevant signature 230 (depicted using black in-fill with white alphabetical letters for nodes that are a part of the most likely match, and the most likely match overlapping relevant signature 230 on a right side of the page).

Due to being almost identical, there may be little (if any) deviation between suspect signature 231 and the portion of relevant signature 230. For example, should there be the little deviation between the graph data structures, suspect signature 231 (as illustrated in FIG. 2G) may overlap a portion of relevant signature 230 and the little deviation between the graph data structures may be between data populated within a single node of both suspect signature 231 and relevant signature 230 corresponding to a same component. Alternatively, the little deviation may be between some relationships associated with the respective nodes corresponding to the same component. For example, a single node of each graph data structure may not include an exact same quantity of edges established for relationships and/or may not be established for relationships of a same type as one another.).

It will be appreciated that although illustrated and discussed in FIG. 2G as matching an unportioned suspect signature 231 to a single portion of relevant signature 230, any number of the portions of suspect signature 231 may be obtained to facilitate an in-depth attempt at matching each of these portions to any portion of relevant signature 230.

In doing so, various portions of suspect signature 231 may be associated with respective sub-levels of similarity that are based on how identical the nodes of suspect signature 231, edges of suspect signature 231, orientation of these nodes and these edges, and data populated to these nodes and established by these edges are to those of relevant signature 230. These sub-levels of similarity may, for example, be used to obtain the level of similarity. For example, each sub-level may indicate a percentage of an associated portion of suspect signature 231 that may be identical to a corresponding portion of relevant signature 230. An average may be obtained for the percentages to obtain the level of similarity between the graph data structures.

It will be appreciated that, although not a single portion of the suspect signature may be remotely similar to any portion of relevant signature 230, a portion of the suspect signature may be obtained nonetheless based on being a best match to the any portion of relevant signature 230.

Due to suspect signature 231 being almost identical to the portion of relevant signature 230, assume the level of similarity is around 90% identical. As previously discussed, the similarity analysis process may further include comparing the level of similarity to the threshold similarity specified by previously discussed criteria. For example, assume the threshold similarity is 60%. Based on this threshold similarity, the criteria may further specify that suspect signature 231 has a high likelihood of including an unauthorized configuration (e.g., a configuration included in relevant signature 230) due to the level of similarity identified at 90% identical meeting, and even exceeding, the threshold similarity of 60%.

For additional information regarding the likelihood of a system including an unauthorized configuration, refer to FIG. 3 further below.

Turning to FIG. 2H, a sixth structural diagram in accordance with an embodiment is shown. It will be appreciated that this sixth structural diagram illustrates a second example of the second process performed as part of the architectural regulation framework. For example, as shown in FIG. 2H, another subgraph comparison process (e.g., similarity analysis process 208 in FIG. 2B) may be performed as part of the architectural regulation framework to obtain a similarity analysis result (e.g., 207 in FIG. 2G).

Previously discussed in FIGS. 2C-2E was the assumption that the level of similarity between relevant signature 230 and suspect signature 232 is below a threshold similarity defined by criteria. As discussed in FIG. 2G, identifying the level of similarity between relevant signature 230 and suspect signature 232 may include performing the similarity analysis process.

For example, the similarity analysis process may include performing the subgraph comparison process where portions of suspect signature 232 are attempted to be matched to portions of relevant signature 230, as shown in FIG. 2H. Therefore, the assumption mentioned above may be based, for example, on a portion of suspect signature 232 that includes less than half of suspect signature 232's graph data structure being almost identical to a portion of relevant signature 230 that includes less than half of relevant signature 230.

For example, suspect signature 232 is depicted in FIG. 2H with arrows indicative of a reorientating of suspect signature 232 (and/or portions of suspect signature 232) until a most likely match is found within relevant signature 230 (depicted using black in-fill with white alphabetical letters for nodes that are a part of the most likely match, and the most likely match overlapping relevant signature 230 on a right side of the page).

Due to less than half of these graph data structures being the best match for one another, there may be a sizable deviation between suspect signature 232 and relevant signature 230. For example, this sizable deviation may indicate that a majority of the artificial intelligence architectures associated with these graph data structures may not match at all and/or may otherwise vary (e.g., vary by a large degree of difference) from one another.

It will be appreciated that although illustrated and discussed in FIG. 2H as matching a single portion of suspect signature 232 to a single portion of relevant signature 230, any number of portions of suspect signature 232 may be obtained to facilitate an in-depth attempt at matching each of these portions to portions of relevant signature 230.

As discussed with regard to suspect signature 231 in FIG. 2G, portions of suspect signature 232 may be associated with respective sub-levels of similarity that are based on how identical the nodes of suspect signature 232, edges of suspect signature 232, orientation of these nodes and these edges, and data populated to these nodes are to those of relevant signature 230. These sub-levels of similarity may, for example, be used to obtain the level of similarity, each sub-level indicating, for example, a percentage of an associated portion of suspect signature 232 that may be a best match to a corresponding portion of relevant signature 230. An average may be obtained for the percentages to obtain the level of similarity between these graph data structures.

Due to suspect signature 231 being significantly different from relevant signature 230, assume the level of similarity is around 30% identical. In the discussion of FIG. 2H, the assumption is made regarding a 60% threshold similarity specified by the previously discussed criteria. Based on this threshold similarity, the criteria may further specify that suspect signature 232 has a low likelihood of including an unauthorized configuration (e.g., a configuration included in relevant signature 230) due to the level of similarity identified at 30% identical falling short of the threshold similarity of 60%.

For additional information regarding unauthorized configurations, refer to FIG. 3 further below.

For additional information and/or examples regarding the architectural regulation framework, refer to FIG. 3 further below.

Thus, as discussed with regard to FIGS. 2A-2H, an architectural regulation framework may be facilitated by any number of devices such as data processing system 100, managed systems 101, other systems 102, and/or management entity 104 cooperating with one another as part of, for example, the system shown and discussed with regard to FIG. 1.

In doing so, portions of such architectures that, for example, are may be included in the knowledge base associated with the management entity and may include any quantity of proprietary information (e.g., considered to be part of proprietary “knowhow” associated with the management entity) that may be utilized by the management entity (and/or the operator and/or the consumer) to provide artificial intelligence based services while mitigating a risk associated with disclosing such proprietary information (e.g., “knowhow”) to possible competitors (e.g., other entities who may be inclined to use such proprietary information without authorization to provide their own artificial intelligence based services as part of their computer implemented services). Therefore, a likelihood of unauthorized configurations being used to provide computer implemented services without authorization to do so may be decreased, and thus, the likelihood of providing such services as expected and/or desired without using such unauthorized configurations may be increased.

While illustrated in FIGS. 2A-2H with a limited number of specific components, a system may include additional, fewer, and/or different components without departing from embodiments disclosed herein.

As discussed above, the components of FIGS. 2A-2H may facilitate and/or perform various functionalities to facilitate the architectural regulation framework. FIG. 3 illustrates a method that may be facilitated and/or performed by the components of FIGS. 1-2H.

In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing operation of a system in accordance with an embodiment is shown. The method may be performed, for example, by a management entity (e.g., 104), and/or any other entity.

At operation 300, a suspect signature is obtained for a suspect system of an operator based on an artificial intelligence architecture used by the suspect system. The suspect signature may be obtained by performing a signature generation process based on data regarding an artificial intelligence architecture used by the suspect system of the operator. For example, included in the artificial intelligence architecture is a quantity of software components that provide artificial intelligence services and hardware components used by the software components. The signature generation process may be based on information regarding these components.

During the signature generation process, for example, and for each component of the quantity of components, (i) a node corresponding to a component may be added to a graph data structure, (ii) the added node may then be populated with information regarding properties of the component, (iii) relationships may then be identified between the component and other component of the components, (iv) edges may be establish between the node and other nodes corresponding to the other components based on the identified relationships, and then once the preceding steps are performed for all of the components included in the artificial intelligence architecture, (v) the graph data structure may be completed to obtain the suspect signature.

For example, the populating of the node may include (i) associating configuration settings of the corresponding component with the node, (ii) associating a portion of the artificial intelligence services to which the component contributes to the node, and (iii) information regarding data used by the component in the portion of the artificial intelligence services.

Additionally, for example, the identifying of the relationships may include (i) identifying sources of information used by the component, (ii) identifying a portion of the other nodes corresponding to other components that are the sources of the information, (iii) establishing a portion of the edges between the node and the portion of the other nodes, and (iv) applying, to each edge of the portion of the edges, a label indicating that other software components corresponding to the portion of the nodes are the sources of the information and/or a flow direction of the information.

For additional information regarding the obtaining of the suspect signature, refer back to the discussions of FIG. 2A, 2D-2E, and 2G-2H.

At operation 302, a relevant signature is obtained using a knowledge base of proprietary artificial intelligence architectures and information regarding managed artificial intelligence based systems that are managed on behalf of the operator, the suspect system not being any of the managed systems, and the relevant signature being based on a subset of the knowledge base used by the managed systems. The relevant signature may be obtained by, for example, filtering, based on the information regarding managed artificial intelligence based systems that are managed on behalf of the operator, the knowledge base to obtain the subset of the knowledge base to be used as the relevant signature. This filtered subset may be based on, for example, the information regarding the managed systems. Thus, by filtering the subset from the knowledge base, the relevant signature may be obtained. Therefore, the relevant signature may also be based on the information regarding the managed systems.

For additional information regarding the obtaining of the relevant signature, refer back to the discussions of FIGS. 2B, 2C, and 2F.

At operation 304, a level of similarity is identified between the suspect signature and the relevant signature. The level of similarity may be identified by using a subgraph comparison process (e.g., discussed with regard to similarity analysis process 208 in FIG. 2B) to compare the graph data structures of the suspect signature and the relevant signature.

For example, during the subgraph comparison process, an attempt may be made to match portions of the suspect signature to portions of the relevant signature. Each of these portions of the suspect signature may be implemented by portions of a graph data structure that are based on the artificial intelligence architecture used by the suspect system, and the portions of the relevant signature may be implemented by portions of a graph data structure that are based on the artificial intelligence architectures used by the managed systems (e.g., 101 in FIG. 1). Thus, the portions of the suspect signature may be respectively compared to each of the portions of the relevant signature to determine to what degree may the portions match one another (e.g., to what degree are they similar to one another). This degree of matching between the portions may be further compared to determine an overall degree of matching between all the portions of the suspect signature and all the portions of the relevant signature. Such a comparison may result in the level of similarity between the suspect signature and the relevant signature being identified.

It will be appreciated that portions of the suspect signature may share a degree of similarity with the portions of the relevant signature that falls anywhere below just short of a perfect match between the suspect signature and the relevant signature. For example, the portions may be prevented from perfectly matching one another due to slight and/or large (e.g., significantly different) differences between the portions such as differences between comparable nodes from the suspect signature and the relevant signature. For example, (i) differences between components corresponding to the comparable nodes, (ii) differences in data populated to the comparable nodes, (iii) differences in relationships of the comparable nodes established by the edges. However, the prevention of a perfect match by, for example, slight differences may not prevent the level of similarity from being indicative of the suspect system including an unauthorized configuration, the unauthorized configuration being a configuration of the managed systems that has been copied and/or used to obtain a highly similar version of the configuration for unauthorized use by the suspect system.

For additional information regarding the level of similarity, refer back to the discussions of FIGS. 1-2E, and 2G-2H.

At operation 306, a determination is made regarding whether the level of similarity meets criteria. The determination may be made by (i) identifying a threshold level of similarity specified by the criteria and (ii) comparing the threshold level of similarity to the level of similarity between the suspect signature and the relevant signature. The determination may thus be made, a result of the determination being based on whether the level of similarity (i) meets and/or exceeds the threshold of similarity, thereby meeting the criteria, or (ii) falls short of the threshold of similarity, thereby not meeting the criteria.

If determined that the level of similarity meets the criteria, then the method may proceed to operation 308. Otherwise, the method may proceed to operation 312 following operation 306.

For additional information regarding the threshold similarity, refer back to the discussions of FIGS. 1, 2B, 2D-2E, and 2G-2H.

At operation 308, it is concluded that the suspect system has an unauthorized configuration. This may be concluded via an association between (i) an occurrence of the level of similarity between the suspect signature and the relevant signature that meets and/or exceeds the threshold specified by the criteria and (ii) an increased likelihood of accurately predicting that the suspect system includes the unauthorized configuration.

In some cases, such an association may be included directly in the criteria via, for example, rules specified by the criteria. For example, the criteria may explicitly define a set of rules that establishes requirements for proving inclusion of the unauthorized configuration in the suspect system. Such requirements may be defined by the criteria to include an occurrence of the level of similarity meeting and/or exceeding the threshold.

It will be appreciated that this conclusion may, in some cases, depend on additional verification that portions of the suspect system share the degree of similarity that meets and/or exceeds the threshold with portions of the managed systems. This additional verification may include verifying that a highly similar configuration (if not a same configuration) is shared between the managed systems and the suspect system, the highly similar configuration being unauthorized for use by any system outside of a managed system that was originally authorized to use such a configuration (and therefore, unauthorized for use by the suspect system).

For example, if following a claim that the suspect system was developed without knowledge of the managed systems, such unlikely similarity may depend on intractably complicated and/or different computations to result in the degree of similarity exceeding the threshold. In such an example, an accidental level of similarity that exceeds the threshold may be almost impossible to prove by, for example, an entity associated with the operator.

For additional information regarding unauthorized configurations, refer back to the discussions of FIG. 1 and/or FIGS. 2A-2H.

At operation 310, at least one action is performed to initiate updating of operation of the suspect system to prevent use of the unauthorized configuration in computer implemented services provided by the suspect system. The at least one action may be performed by, for example, (i) notifying entities associated with the operator to which the unauthorized configuration is disclosed of the conclusion regarding the inclusion of the unauthorized configuration in the suspect system, (ii) terminating operation of the suspect system based on the conclusion regarding the inclusion of the unauthorized configuration in the suspect system, and/or (iii) other processes not to be limited by embodiments herein that may otherwise initiate the updating of the operation of the suspect system to prevent use of the unauthorized configuration in computer implemented services provided by the suspect system.

The method may end following operation 310.

Returning to operation 306, if determined that the level of similarity does not meet the criteria, the method may proceed to operation 312.

At operation 312, it is concluded that the suspect system does not have an unauthorized configuration. This may be concluded via an association between (i) an occurrence of the level of similarity between the suspect signature and the relevant signature that does not meet and/or exceed the threshold specified by the criteria and (ii) a decreased likelihood of the suspect system including the unauthorized configuration. For example, should the suspect system include the unauthorized configuration, the level of similarity may, at minimum, meet the threshold similarity.

For additional information regarding the unauthorized configurations, refer back to the discussions of FIG. 1 and/or FIGS. 2A-2H.

The method may end following operation 312.

Thus, using the method illustrated in FIG. 3, embodiments disclosed herein may manage systems to mitigate a likelihood of using unauthorized portions of artificial intelligence architectures to provide computer implemented services.

Any of the processes and/or components illustrated in and/or discussed with regard to FIGS. 1-3 may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a system, the method comprising:
obtaining, for a suspect system of an operator, a suspect signature based on an artificial intelligence architecture used by the suspect system;
obtaining a relevant signature using a knowledge base of proprietary artificial intelligence architectures and information regarding managed artificial intelligence based systems that are managed on behalf of the operator, the suspect system not being any of the managed artificial intelligence based systems, and the relevant signature being based on a subset of the knowledge base used by the managed artificial intelligence based systems;
identifying a level of similarity between the suspect signature and the relevant signature; and
in an instance of the identifying where the level of similarity meets criteria:
concluding that the suspect system has an unauthorized configuration, and
performing at least one action to initiate updating of operation of the suspect system to prevent use of the unauthorized configuration in computer implemented services provided by the suspect system.

2. The method of claim 1, wherein the obtaining of the suspect signature comprises:
for each component of components of the artificial intelligence architecture:
adding, to a graph data structure, a node corresponding to the component;
populating the node with information regarding properties of the component;
identifying relationships between the component and other component of the components; and
establishing, between the node and other nodes corresponding to the other components, edges based on the relationships.

3. The method of claim 2, wherein the components comprise:
software components that provide artificial intelligence services; and
hardware components used by the software components.

4. The method of claim 3, wherein populating the node comprises:
in an instance of the populating where the node corresponds to one of the software components:
associating configuration settings of the one of the software components with the node;
associating a portion of the artificial intelligence services to which the one of the software components contributes to the node; and
associating information regarding data used by the one of the software components in the portion of the artificial intelligence services to the node.

5. The method of claim 3, wherein populating the node comprises:
in an instance of the populating where the node corresponds to one of the hardware components:
associating configuration settings of the one of the hardware components with the node;
associating a portion of the artificial intelligence services to which the one of the hardware components contributes to the node; and
associating information regarding data used by the one of the hardware components in the portion of the artificial intelligence services to the node.

6. The method of claim 3, wherein identifying the relationships comprises:
in an instance of the populating where the node corresponds to one of the software components:
identifying sources of information used by the one of the software components;
identifying a portion of the other nodes corresponding to other software components that are the sources of the information;
establishing a portion of the edges between the one of the software components and the portion of the other nodes; and
applying, to each edge of the portion of the edges, a label indicating that other software components corresponding to the portion of the nodes are the sources of the information and/or a flow direction of the information.

7. The method of claim 3, wherein identifying the relationships comprises:
in an instance of the populating where the node corresponds to one of the software components:
identifying sources of information used by the one of the software components;
identifying a portion of the other nodes corresponding to hardware components that are the sources of the information;
establishing a portion of the edges between the one of the software components and the portion of the other nodes; and
applying, to each edge of the portion of the edges, a label indicating that hardware components corresponding to the portion of the nodes are the sources of the information and/or a flow direction of the information.

8. The method of claim 3, wherein identifying the relationships further comprises:
in an instance of the populating where the node corresponds to one of the hardware components:
identifying sources of information used by the one of the hardware components;
identifying a portion of the other nodes corresponding to software components that are the sources of the information;
establishing a portion of the edges between the one of the hardware components and the portion of the other nodes; and
applying, to each edge of the portion of the edges, a label indicating that other software components corresponding to the portion of the nodes are the sources of the information and/or a flow direction of the information.

9. The method of claim 1, wherein the relevant signature is based on a portion of the knowledge base that has been disclosed to the operator through being managed on behalf of the operator.

10. The method of claim 9, wherein the level of similarity is identified using a subgraph comparison process where portions of the suspect signature is attempted to be matched to portions of the relevant signature.

11. The method of claim 1, wherein the criteria is a threshold level of similarity.

12. A non-transitory machine-readable medium having instructions stored therein, which when executed by a processor, cause the processor to perform operations for managing operation of a system, the operations comprising:
a obtaining, for a suspect system of an operator, a suspect signature based on an artificial intelligence architecture used by the suspect system;
obtaining a relevant signature using a knowledge base of proprietary artificial intelligence architectures and information regarding managed artificial intelligence based systems that are managed on behalf of the operator, the suspect system not being any of the managed artificial intelligence based systems, and the relevant signature being based on a subset of the knowledge base used by the managed artificial intelligence based systems;
identifying a level of similarity between the suspect signature and the relevant signature; and
in an instance of the identifying where the level of similarity meets criteria:
concluding that the suspect system has an unauthorized configuration, and
performing at least one action to initiate updating of operation of the suspect system to prevent use of the unauthorized configuration in computer implemented services provided by the suspect system.

13. The non-transitory machine-readable medium of claim 12, wherein the obtaining of the suspect signature comprises:
for each component of components of the artificial intelligence architecture:
adding, to a graph data structure, a node corresponding to the component;
populating the node with information regarding properties of the component;
identifying relationships between the component and other component of the components; and
establishing, between the node and other nodes corresponding to the other components, edges based on the relationships.

14. The non-transitory machine-readable medium of claim 13, wherein the components comprise:
software components that provide artificial intelligence services; and
hardware components used by the software components.

15. The non-transitory machine-readable medium of claim 12, wherein the level of similarity is identified using a subgraph comparison process where portions of the suspect signature is attempted to be matched to portions of the relevant signature.

16. The non-transitory machine-readable medium of claim 12, wherein the criteria is a threshold level of similarity.

17. A data processing system, comprising:
a processor; and
a memory coupled to the processor to store instructions, which when executed by the processor, cause the processor to perform operations for managing operation of a system, the operations comprising:
obtaining, for a suspect system of an operator, a suspect signature based on an artificial intelligence architecture used by the suspect system;
obtaining a relevant signature using a knowledge base of proprietary artificial intelligence architectures and information regarding managed artificial intelligence based systems that are managed on behalf of the operator, the suspect system not being any of the managed artificial intelligence based systems, and the relevant signature being based on a subset of the knowledge base used by the managed artificial intelligence based systems;
identifying a level of similarity between the suspect signature and the relevant signature; and
in an instance of the identifying where the level of similarity meets criteria:
concluding that the suspect system has an unauthorized configuration, and
performing at least one action to initiate updating of operation of the suspect system to prevent use of the unauthorized configuration in computer implemented services provided by the suspect
system.

18. The data processing system of claim 17, wherein the obtaining of the suspect signature comprises:
for each component of components of the artificial intelligence architecture:
adding, to a graph data structure, a node corresponding to the component;
populating the node with information regarding properties of the component;
identifying relationships between the component and other component of the components; and
establishing, between the node and other nodes corresponding to the other components, edges based on the relationships.

19. The data processing system of claim 18, wherein the components comprise:
software components that provide artificial intelligence services; and
hardware components used by the software components.

20. The data processing system of claim 17, wherein the level of similarity is identified using a subgraph comparison process where portions of the suspect signature is attempted to be matched to portions of the relevant signature.
